(19) United States
(12) Patent Application Publication
(10) Pub. No.: US 2025/0274058 A1
(43) Pub. Date: Aug. 28, 2025

(54) DRIVING MECHANISM

(71) Applicant: TDK CORPORATION, Tokyo (JP)

(72) Inventors: Pai-Jui Cheng, Taoyuan City (TW); Shu-Shan Chen, Taoyuan City (TW); Chuan-Min Lee, Taoyuan City (TW)

(73) Assignee: TDK CORPORATION, Tokyo (JP)

(21) Appl. No.: 19/052,744

(22) Filed: Feb. 13, 2025

Related U.S. Application Data
(60) Provisional application No. 63/557,758, filed on Feb. 26, 2024.

(30) Foreign Application Priority Data
Apr. 30, 2024 (CN) 202420934890.2

(51) Int. Cl. H02N 2/02

(52) U.S. Cl. CPC H02N 2/025

(57) ABSTRACT

A driving mechanism is provided. The driving mechanism includes a fixed assembly, a movable member, and a driving assembly. The movable member is movable relative to the fixed assembly. The driving assembly is configured to drive the movable member to move relative to the fixed assembly. The driving assembly includes a driving body and a driving portion. The driving portion receives external control signals and then deforms to push the driving body to deform, thereby driving a contact member located on the movable portion to move in a first dimension or a second dimension.

### CROSS REFERENCE TO RELATED APPLICATIONS

This application claims the benefit of U.S. Provisional Application No. 63/557,758, filed on Feb. 26, 2024 and China Patent Application No. 202420934890.2 filed on Apr. 30, 2024, the entirety of which are incorporated by reference herein.

### BACKGROUND OF THE INVENTION

### Field of the Disclosure

The present disclosure relates to a driving mechanism, and in particular it relates to a driving mechanism having a piezoelectric element.

### Description of the Related Art

As technology has developed, many of today's electronic devices (such as smartphones and digital cameras) have components such as motors to drive lenses and other components. However, the displacement accuracy of conventional motors, such as stepper motors and voice coil motors, cannot meet certain specific requirements.

Therefore, how to design a driving mechanism that can improve displacement accuracy and achieve miniaturization are topics nowadays that need to be discussed and solved.

### BRIEF SUMMARY OF THE INVENTION

According to some embodiments of the disclosure, a driving mechanism is provided. The driving mechanism includes a fixed assembly, a movable member, and a driving assembly. The movable member is movable relative to the fixed assembly. The driving assembly is configured to drive the movable member to move relative to the fixed assembly.

According to some embodiments, the driving assembly includes a driving body and a contact member. The driving body has a flexible structure. The driving body includes a fixed portion and a movable portion. The movable portion is movable relative to the fixed portion. The contact member is disposed on the movable portion. The contact member has a contact portion, configured to contact and apply a driving force to the movable member. The driving assembly further includes a driving portion configured to drive the movable portion and the contact member to move relative to the fixed portion. The movable portion and the driving portion are arranged along a first axis.

According to some embodiments, the driving body further includes a first flexible portion and a first connecting portion. The movable portion is movably connected to the fixed portion via the first flexible portion. The first connecting portion is connected to the driving portion, and the first connecting portion has a first connecting surface which faces the driving portion. The driving portion has a first surface which faces the first connecting portion and is connected to the first connecting surface.

According to some embodiments, the driving body further includes a second connecting portion which is connected to the driving portion, and the second connecting portion has a second connecting surface which faces the driving portion. The driving portion has a second surface which faces the second connecting portion and is connected to the second connecting surface. The first connecting surface is perpendicular to the first axis.

According to some embodiments, the first flexible portion has a first flexible portion surface which is perpendicular to a second axis. When viewed along the second axis, the first flexible portion does not overlap the driving portion. The first axis and the second axis are perpendicular to each other. The first flexible portion and the driving portion are arranged along a third axis. The third axis, the first axis and the second axis are perpendicular to each other.

According to some embodiments, the first flexible portion further has a second flexible portion surface. The first flexible portion surface and the second flexible portion surface face opposite directions. The first flexible portion further has a first notch and a second notch. The first notch is formed on the first flexible portion surface. The second notch is formed on the second flexible portion surface.

According to some embodiments, when viewed along the second axis, the first notch overlaps at least a portion of the second notch. The depth of the first notch is different from the depth of the second notch. The first flexible portion further has a third flexible portion surface and a fourth flexible portion surface. The third flexible portion surface is perpendicular to the first flexible portion surface. The fourth flexible portion surface and the third flexible portion surface face opposite directions.

According to some embodiments, the first flexible portion further has a third notch and a fourth notch. The third notch is formed on the third flexible portion surface. The fourth notch is formed on the fourth flexible portion surface. When viewed along the third axis, the third notch overlaps at least a portion of the fourth notch. The depth of the third notch is different from the depth of the fourth notch.

According to some embodiments, the driving portion is configured to drive the movable portion to move in a first dimension, and movement in the first dimension at least includes movement along the second axis. When the driving portion drives the movable portion to move, the movement trajectory of the contact portion is an arc trajectory. The arc trajectory has a closed structure. The arc trajectory has a center.

According to some embodiments, the arc trajectory defines a central axis which passes through the center. The central axis is parallel to the third axis. The central axis is perpendicular to the second axis. When viewed along the first axis or the third axis, the central axis does not pass through the center of the driving portion.

According to some embodiments, the driving mechanism further includes a positioning assembly configured to be affixed to the driving assembly. The positioning assembly includes a positioning member and an elastic member. The positioning member has a long strip-shaped structure. The positioning member passes through a portion of the fixed assembly and the fixed portion of the driving assembly.

According to some embodiments, the elastic member sheathes the positioning member. The elastic member is disposed between the driving assembly and the fixed assembly. The elastic member is configured to apply a stabilizing force onto the driving assembly. The direction of the stabilizing force is not perpendicular to the direction of the driving force. The direction of the stabilizing force is not parallel to the first flexible portion surface.

According to some embodiments, the fixed assembly includes an outer casing and a base. The outer casing is fixedly connected to the base along the second axis. When viewed along the first axis, the outer casing and the base surround the driving assembly.

According to some embodiments, the outer casing of the fixed assembly has an avoiding portion corresponding to the second flexible portion surface. The avoiding portion has an avoiding portion surface which faces the second flexible portion surface. The driving mechanism further includes a limiting element. The limiting element is disposed on the fixed assembly and has a limiting surface which faces the driving assembly. The limiting surface is parallel to the second axis and perpendicular to the first axis. The limiting surface is in direct contact with a fixed surface of the driving assembly.

According to some embodiments, the positioning member has a first threaded structure. The driving body of the driving assembly has a second threaded structure corresponding to the first threaded structure. The first threaded structure is configured to be screwed to the second threaded structure so that the fixed portion of the driving body is located in a fixed position. When viewed along the third axis, the positioning member extends along a first extension direction. When viewed along the third axis, the driving body extends along a second extension direction. The first extension direction is not perpendicular to the second extension direction.

According to some embodiments, the positioning member has a limit portion configured to limit the driving assembly to a fixed position. When the driving assembly is located in the fixed position, the driving assembly contacts the limit portion. The limit portion has a limit surface which faces the driving assembly. When viewed along the direction perpendicular to the second axis, at least a portion of the driving assembly is located between the limit portion and the elastic member. The avoiding portion surface of the avoiding portion is not perpendicular or parallel to the first flexible portion surface.

According to some embodiments, the driving assembly has a first opening, and at least a portion of the positioning member is located in the first opening. The positioning member defines a first extension direction. The positioning member extends along the first extension direction. When viewed in the first extension direction, the area of the first opening is greater than the area of the first cross section of the positioning member. The first extension direction is perpendicular to the first cross section.

According to some embodiments, the area of the first opening is at least 5% greater than the area of the first cross section. When viewed in the first extension direction, the first opening has a long strip-shaped structure, and the first opening defines a stretch direction. When viewed in the first extension direction, a connecting line of the center of the positioning member and the center of the contact member is parallel to the stretch direction.

According to some embodiments, when the driving assembly receives a first control signal, the driving assembly drives the contact member to move in the first dimension. When the driving assembly receives a second control signal, the driving assembly drives the contact member to move in a second dimension. The second dimension is opposite to the first dimension. The first control signal and the second control signal have periodic characteristics. The frequency of the first control signal is the same as the frequency of the second control signal.

According to some embodiments, when the driving assembly receives a first control signal, the driving assembly drives the contact member to move in the first dimension. When the driving assembly receives a second control signal, the driving assembly drives the contact member to move in a second dimension. The second dimension is opposite to the first dimension. The first control signal and the second control signal have periodic characteristics. The frequency of the first control signal is different from the frequency of the second control signal.

The present disclosure provides a driving mechanism, which includes a fixed assembly, a movable member and a driving assembly. The driving assembly is configured to drive the movable member to move relative to the fixed assembly. The driving assembly may include a driving body and a driving portion. The driving portion can receive external control signals and then deforms to push the driving body to deform, thereby driving the contact member located on the movable portion to move in the first dimension or the second dimension. When the contact member moves, the contact member will repeatedly contact the movable member, thereby driving the movable member to move, such as moving in the first direction or the second direction.

In some embodiments, when the driving portion receives the first control signal, the driving assembly drives the contact member to move clockwise along an arc trajectory, and when the driving portion of the driving assembly receives the second control signal, the driving assembly drives the contact member to move counterclockwise along the arc trajectory. Based on this design, the driving member can quickly drive the movable member to move back and forth along the first axis, and the displacement accuracy can be greatly improved compared to a traditional motor.

In addition, because the driving mechanism of the present disclosure does not require traditional coils, magnets and additional pushing elements, the overall volume of the driving mechanism can be effectively reduced to achieve the purpose of miniaturization, and because the driving portion is the piezoelectric element, it can provide a greater driving force than the traditional coil motor, so as to push a larger and heavier object.

Additional features and advantages of the disclosure will be set forth in the description which follows, and, in part, will be obvious from the description, or can be learned by practice of the principles disclosed herein. The features and advantages of the disclosure can be realized and obtained by means of the instruments and combinations pointed out in the appended claims. These and other features of the disclosure will become more fully apparent from the following description and appended claims, or can be learned by the practice of the principles set forth herein.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a perspective view of the driving mechanism 100 according to an embodiment of the present disclosure.

FIG. 2 is an exploded view of the driving mechanism 100 according to one embodiment of the present disclosure.

FIG. 3 is a cross-sectional view of the driving mechanism 100 along line A-A in FIG. 1 according to an embodiment of the present disclosure.

FIG. 4 is an exploded diagram of the driving assembly DA of the driving mechanism 100 according to an embodiment of the present disclosure.

FIG. 5 is a top view of the driving assembly DA according to an embodiment of the present disclosure.

FIG. 6 is a side view of the driving assembly DA according to an embodiment of the present disclosure.

FIG. 7 is a rear view of the driving assembly DA according to an embodiment of the present disclosure.

FIG. 8 to FIG. 10 are side views illustrating that the driving body 104 deforms to drive the contact member 105 to move and located in different positions according to an embodiment of the present disclosure.

FIG. 11 is a schematic diagram illustrating that the driving assembly DA drives the movable member 108 to move in a first direction D1 according to an embodiment of the present disclosure.

FIG. 12 is a schematic diagram illustrating that the driving assembly DA drives the movable member 108 to move in a second direction D2 according to an embodiment of the present disclosure.

FIG. 13 is a cross-sectional view of a driving mechanism 100A according to another embodiment of the present disclosure.

FIG. 14 is a top view of the driving assembly DA according to another embodiment of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

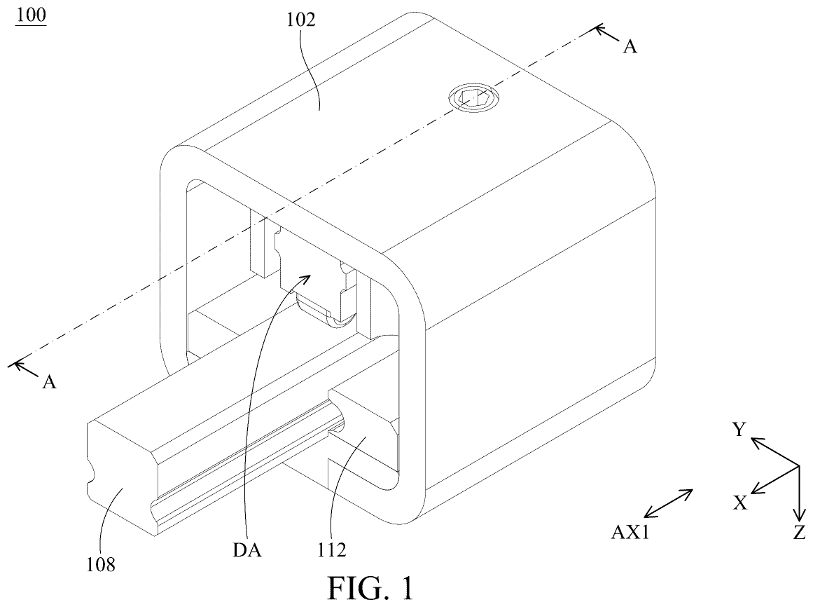

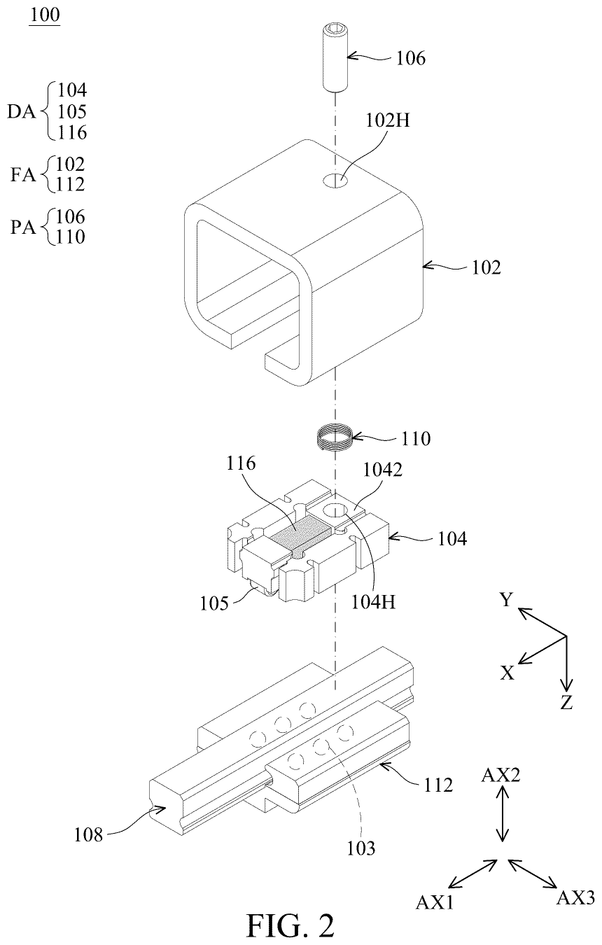

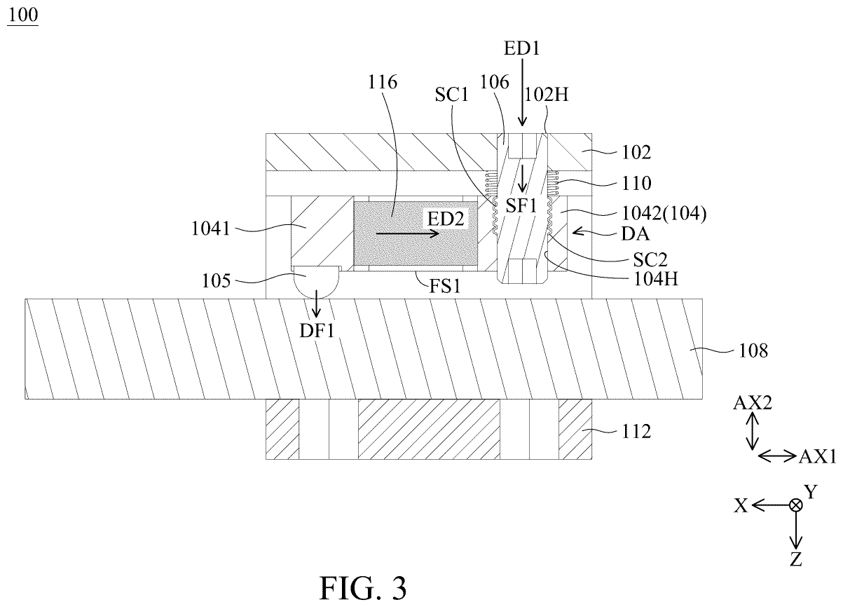

Please refer to FIG. 1 to FIG. 3. FIG. 1 is a perspective view of the driving mechanism 100 according to an embodiment of the present disclosure. FIG. 2 is an exploded view of the driving mechanism 100 according to one embodiment of the present disclosure, and FIG. 3 is a cross-sectional view of the driving mechanism 100 along line A-A in FIG. 1 according to an embodiment of the present disclosure. The driving mechanism 100 can be, for example, a driving linear motor configured to drive various components for linear movement. The driving mechanism 100 can carry larger weight components and can be applied to high-precision instruments such as 3D printers and electron microscopes.

In this embodiment, the driving mechanism 100 may include a fixed assembly FA, a movable member 108 and a driving assembly DA. The movable member 108 is movable relative to the fixed assembly FA. The driving assembly DA is configured to drive the movable member 108 to move along a first axis AX1 (the X-axis) relative to the fixed assembly FA. As shown in FIG. 1, when viewed along the first axis AX1, the driving assembly DA is located between the fixed assembly FA and the movable member 108.

In this embodiment, as shown in FIG. 2, the fixed assembly FA may include an outer casing 102 and a base 112, and the outer casing 102 is fixedly connected to the base 112 along a second axis AX2. The outer casing 102 and the base 112 can be made of metal or plastic material, and these two can be locked with screws or bonded with glue, but they are not limited thereto.

When viewed along the first axis AX1, the outer casing 102 and the base 112 surround the driving assembly DA. In addition, as shown in FIG. 2, the driving mechanism 100 further includes a plurality of rolling balls 103, which are arranged between the base 112 and the movable member 108, so that the movable member 108 can move relative to the base 112. It should be noted that the means of moving the movable member 108 relative to the base 112 is not limited to the rolling balls 103 in this embodiment.

In this embodiment, the driving assembly DA is connected to the outer casing 102. For example, as shown in FIG. 2 and FIG. 3, the driving mechanism 100 further includes a positioning assembly PA configured to be affixed to the driving assembly DA and the outer casing 102. In this embodiment, the positioning assembly PA may include a positioning member 106 and an elastic member 110.

The positioning member 106 may have a long strip-shaped structure. For example, the positioning member 106 can be a screw, but it is not limited thereto. The positioning member 106 passes through a hole 102H of the outer casing 102 and a first opening 104H of a fixed portion 1042 of the driving assembly DA to fix the driving assembly DA to the outer casing 102.

Specifically, as shown in FIG. 3, the positioning member 106 may have a first threaded structure SC1, and a driving body 104 of the driving assembly DA may have a second threaded structure SC2, corresponding to the first threaded structure SC1. The first threaded structure SC1 is configured to be screwed to the second threaded structure SC2 so that the fixed portion 1042 of the driving body 104 is located in a fixed position in FIG. 3.

When viewed along a third axis AX3 (the Y-axis), as shown in FIG. 3, the positioning member 106 extends along a first extension direction ED1. When viewed along the third axis AX3, the driving body 104 extends along a second extension direction ED2. Due to tolerances, when the positioning member 106 fixes the driving body 104 to the outer casing 102, the first extension direction ED1 may not be perpendicular to the second extension direction ED2.

Furthermore, the elastic member 110 is, for example, a spring, which sheathes the positioning member 106, but it is not limited thereto. As shown in FIG. 3, the elastic member 110 is disposed between the driving body 104 of the driving assembly DA and the outer casing 102, so that the elastic member 110 is configured to apply a stabilizing force SF1 onto the driving body 104 of the driving assembly DA.

Similarly, due to the aforementioned tolerances, the stabilizing force SF1 may be neither parallel nor perpendicular to a first flexible portion surface FS1 on the driving body 104. That is, the direction of the stabilizing force SF1 may not be perpendicular to the driving body 104.

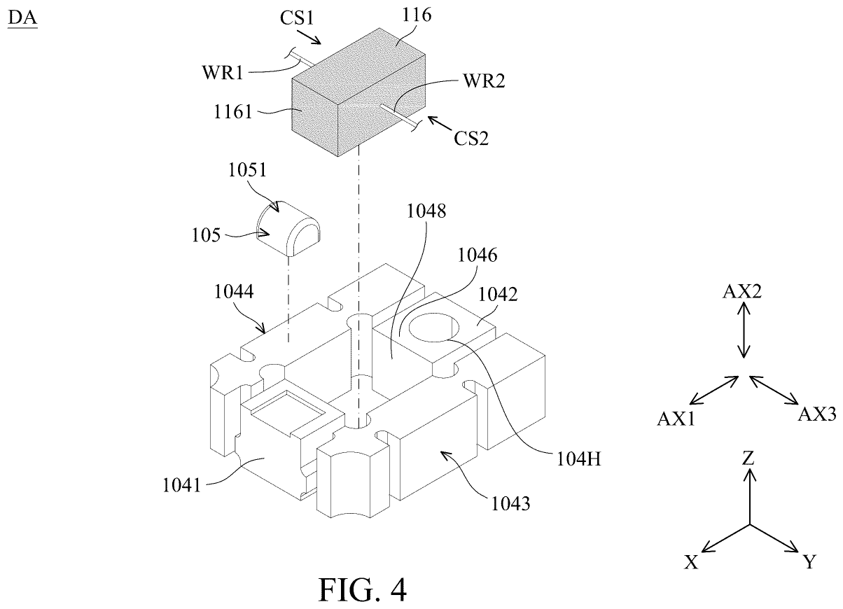

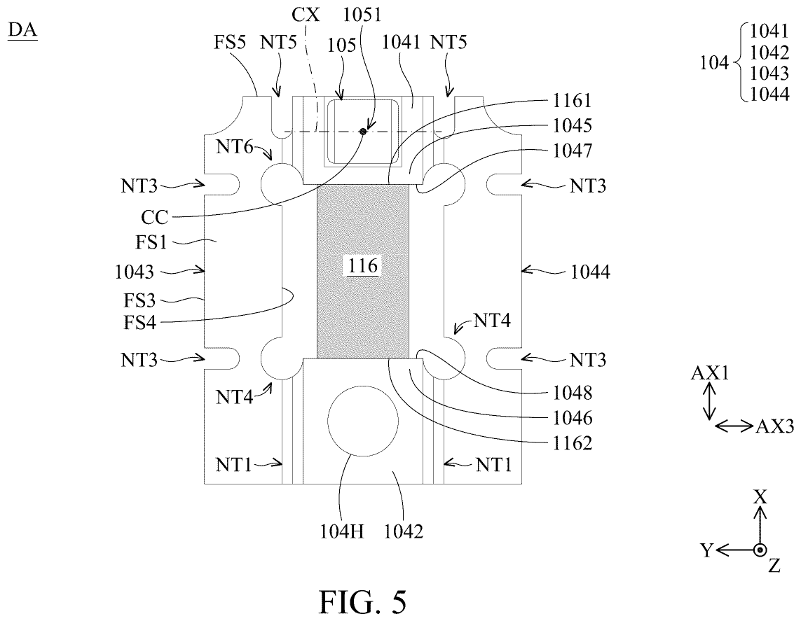

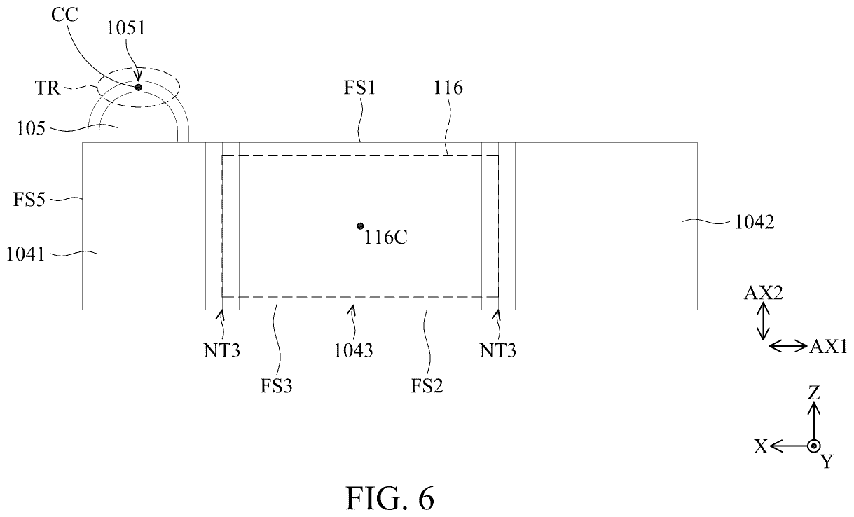

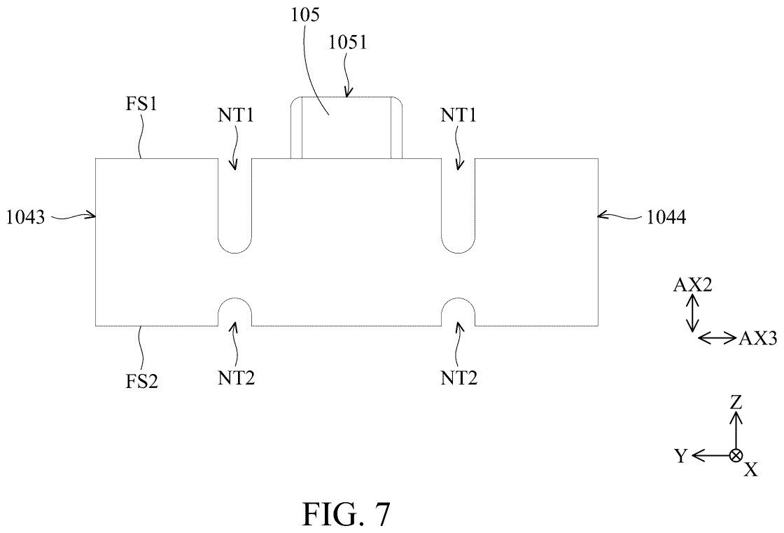

Next, please refer to FIG. 4 to FIG. 7. FIG. 4 is an exploded diagram of the driving assembly DA according to an embodiment of the present disclosure, FIG. 5 is a top view of the driving assembly DA according to an embodiment of the present disclosure, FIG. 6 is a side view of the driving assembly DA according to an embodiment of the present disclosure, and FIG. 7 is a rear view of the driving assembly DA according to an embodiment of the present disclosure.

The driving assembly DA may include the aforementioned driving body 104 and a contact member 105. The driving body 104 has a flexible structure, and the contact member 105 is fixedly disposed on a movable portion 1041 of the driving body 104. In this embodiment, the driving body 104 can be made of a first metal material. For example, the first metal material may include stainless steel. Furthermore, the contact member 105 can be made of a second metal material, and the second metal material can include tool steel, for example, but the materials of the driving body 104 and the contact member 105 are not limited to this embodiment.

As shown in FIG. 3 and FIG. 4, the contact member 105 may have a semi-cylindrical structure, and the contact member 105 may have a contact portion 1051 configured to contact and apply a driving force DF1 to the movable member 108.

The contact portion 1051 is the part that contacts the movable member 108 (a portion of the arc surface in FIG. 4), and the direction of the aforementioned stabilizing force SF1 may not be perpendicular or parallel to the direction of the driving force DF1. Specifically, driving force DF1 may not be parallel to the Z-axis and may change direction as the contact member 105 moves.

Furthermore, as shown in FIG. 4 and FIG. 5, the driving body 104 may include the aforementioned fixed portion 1042 and the movable portion 1041, and the movable portion 1041 is movable relative to the fixed portion 1042. Furthermore, the driving body 104 further includes a first flexible portion 1043, and the movable portion 1041 is movably connected to the fixed portion 1042 via the first flexible portion 1043.

Similarly, the driving body 104 further includes a second flexible portion 1044, and the movable portion 1041 is movably connected to the fixed portion 1042 via the second flexible portion 1044. As shown in FIG. 5, the movable portion 1041 and the fixed portion 1042 are connected between the first flexible portion 1043 and the second flexible portion 1044.

Furthermore, the driving assembly DA may further include a driving portion 116 configured to drive the movable portion 1041 and the contact member 105 to move relative to the fixed portion 1042. The movable portion 1041 and the driving portion 116 are arranged along the first axis AX1 (the X-axis). In this embodiment, the driving portion 116 may be a piezoelectric element, such as being made of piezoelectric ceramics, but it is not limited thereto.

As shown in FIG. 5, the driving body 104 further includes a first connecting portion 1045, which is connected to the driving portion 116, and the first connecting portion 1045 has a first connecting surface 1047, which facing the driving portion 116. The driving portion 116 has a first surface 1161 facing the first connecting portion 1045 and connected to the first connecting surface 1047, such as by elastic glue.

Similarly, the driving body 104 may further include a second connecting portion 1046 which is connected to the driving portion 116, and the second connecting portion 1046 has a second connecting surface 1048 facing the driving portion 116. The driving portion 116 has a second surface 1162 facing the second connecting portion 1046 and connected to the second connecting surface 1048, such as by elastic glue. The first connecting surface 1047 and the second connecting surface 1048 are perpendicular to the first axis AX1.

It should be noted that in this embodiment, the first connecting portion 1045 and the first connecting surface 1047 are located on the movable portion 1041, and the second connecting portion 1046 and the second connecting surface 1048 are located on the fixed portion 1042, but they are not limited thereto. In other embodiments, the first connecting surface 1047 and the second connecting surface 1048 may be located on the inner surfaces of the first flexible portion 1043 and the second flexible portion 1044 respectively. That is, in other embodiments, the driving portion 116 may be connected between the first flexible portion 1043 and the second flexible portion 1044.

As shown in FIG. 5, when viewed along the second axis AX2 (the Z-axis), the first flexible portion 1043 and the second flexible portion 1044 do not overlap the driving portion 116, and the first axis AX1 and the second axis AX2 are perpendicular to each other. Furthermore, the first flexible portion 1043 and the driving portion 116 are arranged along the third axis AX3 (the Y-axis), and the third axis AX3, the first axis AX1 and the second axis AX2 are perpendicular to each other.

Furthermore, as shown in FIG. 5 to FIG. 7, the first flexible portion 1043 may have the aforementioned first flexible portion surface FS1 and a second flexible portion surface FS2, and the first flexible portion surface FS1 and the second flexible portion surface FS2 face opposite directions.

As shown in FIG. 5 and FIG. 7, the first flexible portion 1043 further has a first notch NT1 and a second notch NT2. The first notch NT1 is formed on the first flexible portion surface FS1, and the second notch NT2 is formed on the second flexible portion surface FS2.

When viewed along the second axis AX2, the first notch NT1 overlaps at least a portion of the second notch NT2, and the depth of the first notch NT1 is different from the depth of the second notch NT2. In this embodiment, the depth of the first notch NT1 is greater than the depth of the second notch NT2, but they are not limited thereto.

It should be noted that the second flexible portion 1044 may also have a first notch NT1 and a second notch NT2 as well as other notch structures. That is, the second flexible portion 1044 and the first flexible portion 1043 are symmetrically configured (such as FIG. 5). Therefore, only the detailed structure of the first flexible portion 1043 will be described in the following paragraphs.

In addition, as shown in FIG. 5 and FIG. 6, the first flexible portion 1043 has a third flexible portion surface FS3 and a fourth flexible portion surface FS4, the third flexible portion surface FS3 and the fourth flexible portion Surface FS4 are perpendicular to the first flexible portion surface FS1, and the fourth flexible portion surface FS4 and the third flexible portion surface FS3 face opposite directions.

The first flexible portion 1043 further has two third notch NT3 and a fourth notch NT4. The third notch NT3 is formed on the third flexible portion surface FS3, and the fourth notch NT4 is formed on the fourth flexible portion surface FS4.

As shown in FIG. 5, when viewed along the third axis AX3, one of the third notches NT3 overlaps at least a portion of the fourth notch NT4, and the depth of the third notch NT3 is different from the depth of the fourth notch NT4.

Similarly, as shown in FIG. 5 and FIG. 6, the first flexible portion 1043 has a fifth flexible portion surface FS5, and the fifth flexible portion surface FS5 is perpendicular to the first flexible portion surface FS1.

The first flexible portion 1043 further has a fifth notch NT5 and a sixth notch NT6. The fifth notch NT5 is formed on the fifth flexible portion surface FS5, and the sixth notch NT6 is formed on the fourth flexible portion surface FS4.

When viewed along the first axis AX1, the fifth notch NT5 overlaps at least a portion of the sixth notch NT6, and the depth of the fifth notch NT5 is different from the depth of the sixth notch NT6.

Based on the design of these notches on the first flexible portion 1043 and the second flexible portion 1044, when the driving portion 116 deforms (expanses or contracts), it will drive the first flexible portion 1043, the second flexible portion 1044 and the movable portion 1041 to deform, so that the movable portion 1041 drives the contact member 105 to move.

Therefore, the driving portion 116 is configured to drive the movable portion 1041 and the contact member 105 to move in a first dimension, and the movement in the first dimension includes the movement along the first axis AX1 and the second axis AX2. The specific action manner and range of motion will be described in the following paragraphs.

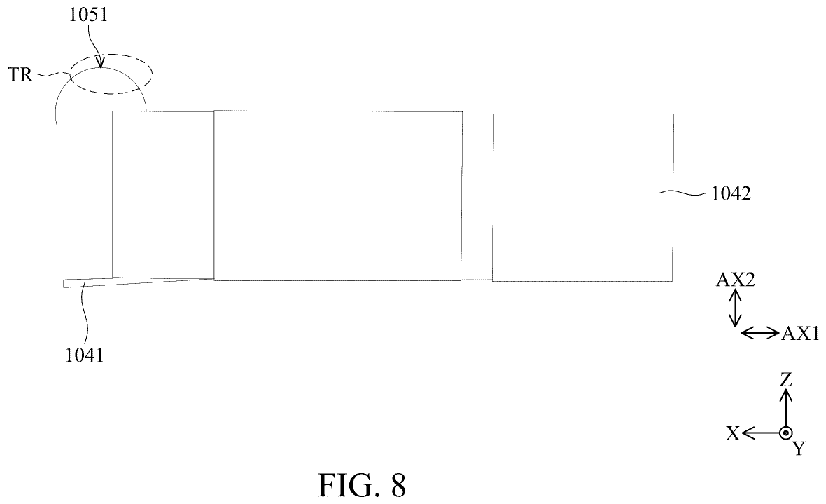

Please refer to FIG. 6 and FIG. 8 to FIG. 10. FIG. 8 to FIG. 10 are side views illustrating that the driving body 104 deforms to drive the contact member 105 to move and located in different positions according to an embodiment of the present disclosure. In this embodiment, the driving portion 116 is configured to receive a first control signal CS1 and a second control signal CS2 from an external control circuit thorough lead wires WR1 and WR2 (FIG. 4) to generate deformation. The external control circuit is, for example, a control chip or a control integrated circuit, but it is not limited thereto.

After receiving the above control signal, the driving portion 116 deforms according to the first control signal CS1 or the second control signal CS2 to push the movable portion 1041, so that the first flexible portion 1043, the second flexible portion 1044 and the movable portion 1041 deform to drive the contact member 105 to move relative to the fixed portion 1042. That is, the fixed portion 1042 does not deform.

The first control signal CS1 and the second control signal CS2 have periodic characteristics, and the frequency of the first control signal CS1 is the same as the frequency of the second control signal CS2. For example, the first control signal CS1 and the second control signal CS2 may be AC square wave signals and have the same frequency, but they are not limited thereto. It is worth noting that in this embodiment, the phase difference between the first control signal CS1 and the second control signal CS2 is 180 degrees.

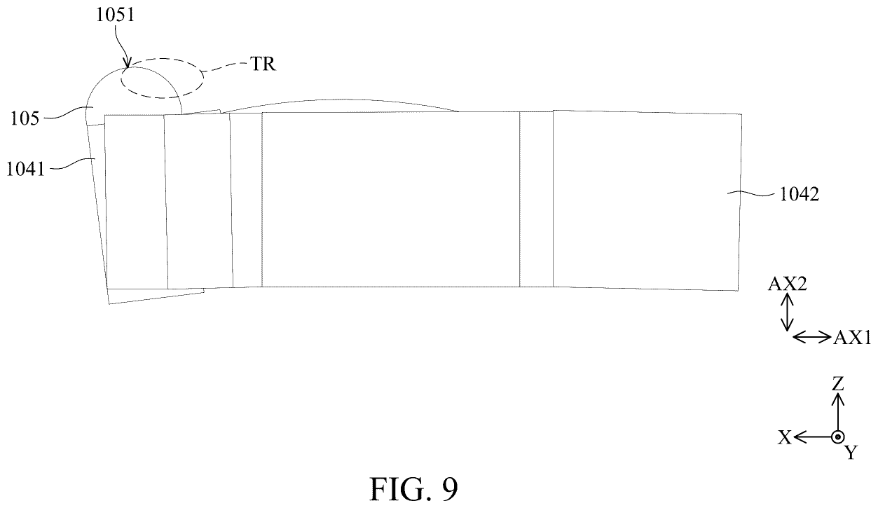

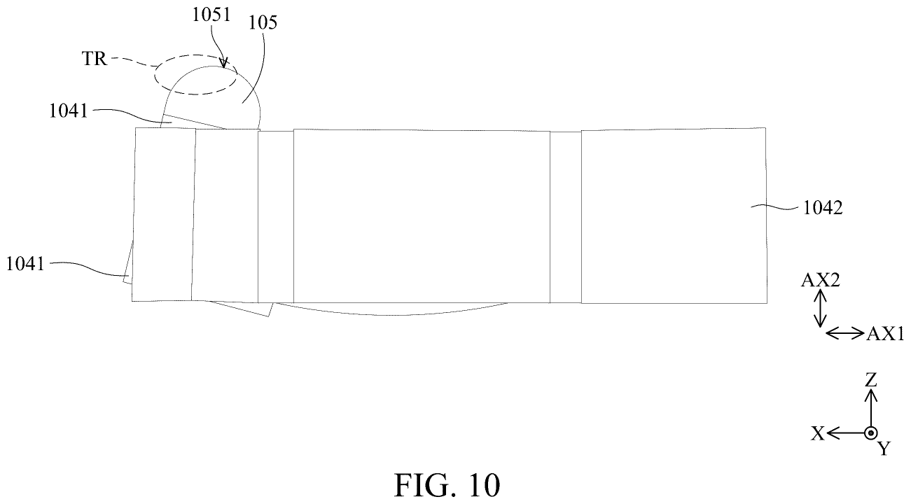

As shown in FIG. 6 FIG. 8 to FIG. 10, when the driving portion 116 receives the first control signal CS1 (for example, the initial phase is 0 degrees), the driving portion 116 will first expand and then contract, to drive the movable portion 1041 to deform, so that the contact member 105 rotates sequentially from the position in FIG. 6 to the positions in FIG. 8, FIG. 9 and FIG. 10, and then returns to the position in FIG. 6.

That is, when the driving portion 116 drives the movable portion 1041 to move, the contact member 105 rotates clockwise, and the movement trajectory of the contact portion 1051 of the contact member 105 is an arc trajectory TR. As shown in FIG. 6, arc trajectory TR is, for example, an elliptical trajectory. The arc trajectory TR has a closed structure, and the arc trajectory TR has a center CC. As shown in FIG. 5 and FIG. 6, the arc trajectory TR defines a central axis CX, and the central axis CX passes through the center CC.

As shown in FIG. 5, the central axis CX is parallel to the third axis AX3, and the central axis CX is perpendicular to the second axis AX2. As shown in FIG. 6, when viewed along the first axis AX1 or the third axis AX3, the central axis CX does not pass through the center 116C of the driving portion 116.

In this embodiment, when the driving portion 116 of the driving assembly DA receives the first control signal CS1, the driving assembly DA drives the contact member 105 to move in the first dimension. That is, the movement of the contact member 105 in the first dimension is the clockwise movement of the contact member 105 along the arc trajectory TR in FIG. 6.

On the contrary, when the driving portion 116 of the driving assembly DA receives the second control signal CS2, the driving assembly DA drives the contact member 105 to move in a second dimension, and the second dimension is opposite to the first dimension. That is, the movement in the second dimension is the counterclockwise movement of the contact member 105 along the arc trajectory TR in FIG. 6.

That is, when the driving portion 116 receives the second control signal CS2 (for example, the initial phase is 180 degrees), the driving portion 116 will first contract and then expand to drive the movable portion 1041 to deform, so that the contact member 105 rotates sequentially from the position in FIG. 6 to the positions in FIG. 10, FIG. 9 and FIG. 8, and then returns to the position in FIG. 6.

In addition, it should be noted that in this embodiment, the frequency of the first control signal CS1 is the same as the frequency of the second control signal CS2, but it is not limited thereto. In other embodiments, the frequency of the first control signal CS1 and the frequency of the second control signal CS2 may be different, but the phase of the first control signal CS1 and the phase of the second control signal CS2 are the same.

For example, when the frequency of the first control signal CS1 is 120 kHz, the contact member 105 moves clockwise along the arc trajectory TR in FIG. 6. On the other hand, when the frequency of the second control signal CS2 is 130 kHz, the contact member 105 moves counterclockwise along the arc trajectory TR in FIG. 6.

Based on the above various configurations of the first control signal CS1 and the second control signal CS2, different means can be used according to different application scenarios to control the movement of the contact member 105. That is, these configurations can increase the flexibility of use and can adapt to different usage environments or driven elements.

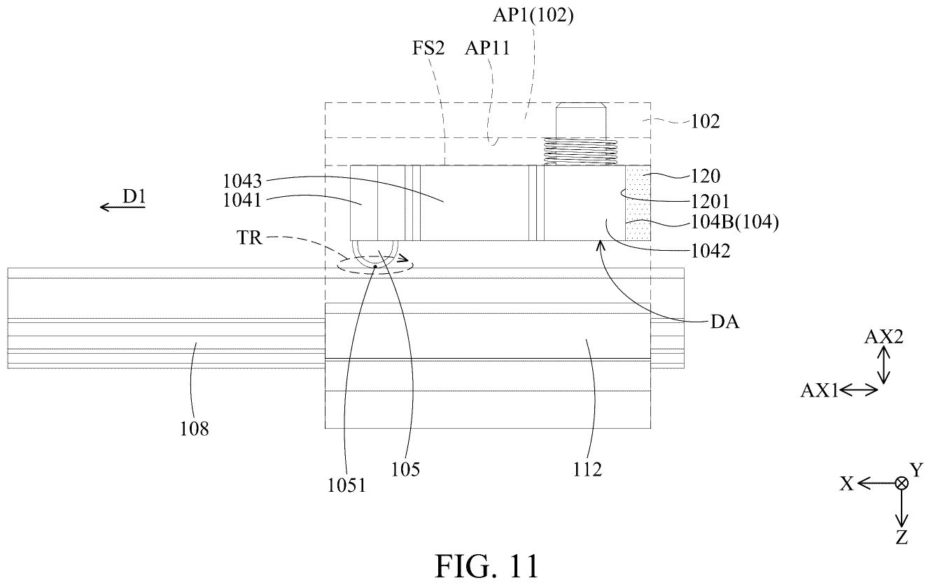

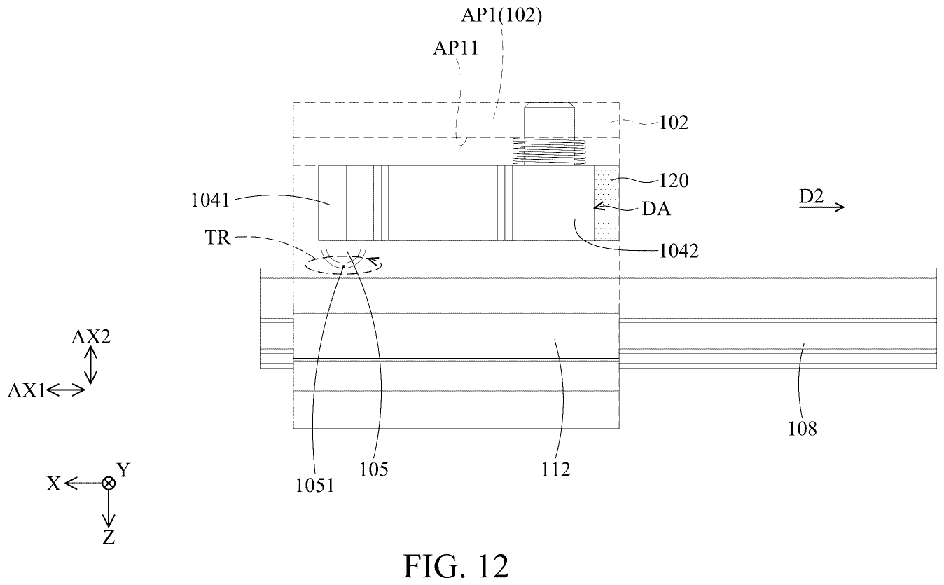

Next, please refer to FIG. 11 to FIG. 12. FIG. 11 is a schematic diagram illustrating that the driving assembly DA drives the movable member 108 to move in a first direction D1 according to an embodiment of the present disclosure, and FIG. 12 is a schematic diagram illustrating that the driving assembly DA drives the movable member 108 to move in a second direction D2 according to an embodiment of the present disclosure.

As shown in FIG. 11, when the contact member 105 is driven by the movable portion 1041 to rotate clockwise, the contact portion 1051 of the contact member 105 switches between a detached state and a contact state. For example, when the contact portion 1051 is located at the upper portion of the arc trajectory TR in FIG. 11, the contact member 105 does not contact the movable member 108 and is in the detached state. On the other hand, when the contact portion 1051 is located at the lower portion of the arc trajectory TR, the contact member 105 is in contact with the movable member 108 and in the contact state, so as to push the movable member 108.

As shown in FIG. 11, when the contact member 105 rapidly rotates clockwise and repeatedly contacts the movable member 108, the movable member 108 can move in the first direction D1. On the other hand, as shown in FIG. 12, when the contact member 105 rapidly rotates counterclockwise and repeatedly contacts the movable member 108, the movable member 108 can move in the second direction D2.

In order to ensure that the movable portion 1041 is not in contact with the outer casing 102 during movement, in this embodiment, the outer casing 102 of the fixed assembly FA may include an avoiding portion AP1 (the top), which corresponds to the second flexible portion surface FS2 of the first flexible portion 1043. The avoiding portion AP1 may have an avoiding surface AP11 which faces the second flexible portion surface FS2.

Along the second axis AX2, there is a gap between the avoiding surface AP11 and the second flexible portion surface FS2, so that it can avoid the problem that the movable portion 1041 collides with the avoiding surface AP11 of the outer casing 102 during movement, thereby causing damage to the movable portion 1041.

Furthermore, in order to ensure that when the movable portion 1041 moves, the fixed portion 1042 can be located on the aforementioned fixed position without moving, the driving mechanism 100 can further include a limiting element 120, fixedly connected to the outer casing 102 and located within the outer casing 102. The limiting element 120 is, for example, a cube, which can be integrally formed with the outer casing 102, but they are not limited thereto.

As shown in FIG. 11, the limiting element 120 may have a limiting surface 1201 which faces the driving assembly DA. The limiting surface 1201 is parallel to the second axis AX2 (the Z-axis) and perpendicular to the first axis AX1, and the limiting surface 1201 is in direct contact with a fixed surface 104B of the driving body 104 of the driving assembly DA.

Based on the configuration of the limiting element 120, the driving assembly DA will be fixed on the aforementioned fixed position without rotating around the second axis AX2 so as to ensure that the contact member 105 can effectively drive the movable member 108 to move in the first direction D1 or the second direction.

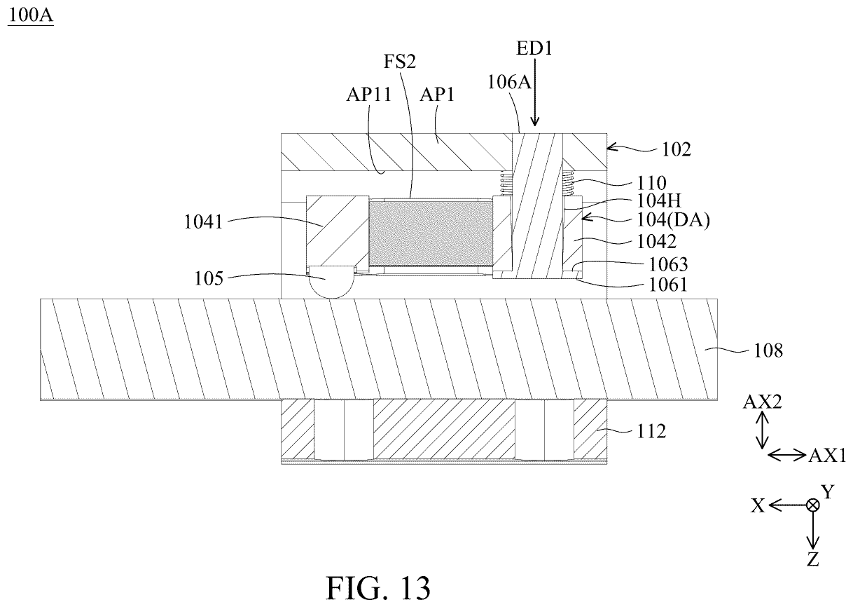

Next, please refer to FIG. 13, which is a cross-sectional view of a driving mechanism 100A according to another embodiment of the present disclosure. This embodiment is similar to the previous embodiment. The difference is that the positioning member 106A can be a guide rod without threads (such as the first threaded structure SC1 of the previous embodiment), and the positioning member 106A can have a limit portion 1061 configured to limit the driving assembly DA to a fixed position.

When the driving assembly DA is located in the fixed position, the driving body 104 of the driving assembly DA contacts the limit portion 1061, and the limit portion 1061 has a limit surface 1063 which faces the driving body 104 of the driving assembly DA. The limit portion 1061 is, for example, a protruding portion of the positioning member 106A, but it is not limited thereto. When viewed in a direction perpendicular to the second axis AX2, as shown in FIG. 13, at least a portion of the driving assembly DA is located between the limit portion 1061 and the elastic member 110.

Similar to the previous embodiment, due to the tolerances, when the positioning member 106A positions the driving body 104 in the fixed position, the avoiding portion surface AP11 of the avoiding portion AP1 may not be perpendicular or parallel to the first flexible portion surface FS1 or the second flexible portion surface FS2.

For example, as shown in FIG. 13, the driving body 104 of this embodiment may pitch down relative to the outer casing 102. That is, the movable portion 1041 and the fixed portion 1042 are not completely on the same horizontal plane (for example, the XY plane), and the angle between the movable portion 1041 (or the fixed portion 1042) and the horizontal plane is less than 5 degrees.

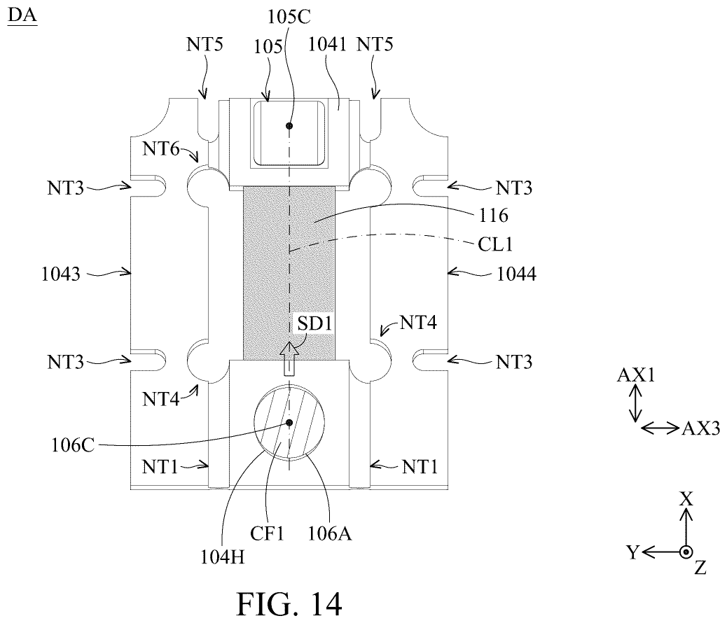

Next, please refer to FIG. 13 and FIG. 14. FIG. 14 is a top view of the driving assembly DA according to another embodiment of the present disclosure. As shown in FIG. 14, the driving body 104 of the driving assembly DA has a first opening 104H, and at least a portion of the positioning member 106A is located in the first opening 104H.

As shown in FIG. 13, similarly, the positioning member 106A can defines the first extension direction ED1 (for example, parallel to the Z-axis), and the positioning member 106A extends along the first extension direction ED1. As shown in FIG. 14, when viewed in the first extension direction ED1, the area of the first opening 104H is greater than the area of a first cross section CF1 of the positioning member 106A. For example, the area of first opening 104H is at least 5% greater than the area of first cross section CF1. The first extension direction ED1 is perpendicular to the first cross section CF1.

When viewed in the first extension direction ED1, the first opening 104H has a long strip-shaped structure, and the first opening 104H defines a stretch direction SD1. When viewed in the first extension direction ED1, the connecting line CL1 of the center 106C of the positioning member 106A and the center 105C of the contact portion 1051 is parallel to the stretch direction SD1.

That is, in this embodiment, the contour of the first opening 104H may be an ellipse, and the stretch direction SD1 overlaps the major axis of the ellipse. Based on such a design, it can avoid the problem that the positioning member 106A is unable to be installed in the first opening 104H due to tolerances.

In conclusion, the present disclosure provides a driving mechanism 100, which includes a fixed assembly FA, a movable member 108 and a driving assembly DA. The driving assembly DA is configured to drive the movable member 108 to move relative to the fixed assembly FA. The driving assembly DA may include a driving body 104 and a driving portion 116. The driving portion 116 can receive external control signals and then deforms to push the driving body 104 to deform, thereby driving the contact member 105 located on the movable portion 1041 to move in the first dimension or the second dimension. When the contact member 105 moves, the contact member 105 will repeatedly contact the movable member 108, thereby driving the movable member 108 to move, such as moving in the first direction D1 or the second direction D2.

In some embodiments, when the driving portion 116 receives the first control signal CS1, the driving assembly DA drives the contact member 105 to move clockwise along an arc trajectory TR, and when the driving portion 116 of the driving assembly DA receives the second control signal CS2, the driving assembly DA drives the contact member 105 to move counterclockwise along the arc trajectory TR. Based on this design, the driving member 105 can quickly drive the movable member 108 to move back and forth along the first axis AX1, and the displacement accuracy can be greatly improved compared to a traditional motor.

In addition, because the driving mechanism of the present disclosure does not require traditional coils, magnets and additional pushing elements, the overall volume of the driving mechanism 100 can be effectively reduced to achieve the purpose of miniaturization, and because the driving portion 116 is the piezoelectric element, it can provide a greater driving force than the traditional coil motor, so as to push a larger and heavier object.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. A driving mechanism, comprising:
a fixed assembly;
a movable member, movable relative to the fixed assembly; and
a driving assembly, configured to drive the movable member to move relative to the fixed assembly.

2. The driving mechanism as claimed in claim 1, wherein
the driving assembly includes a driving body and a contact member;
the driving body has a flexible structure;
the driving body includes a fixed portion and a movable portion;
the movable portion is movable relative to the fixed portion;
the contact member is disposed on the movable portion;
the contact member has a contact portion, configured to contact and apply a driving force to the movable member;
the driving assembly further includes a driving portion configured to drive the movable portion and the contact member to move relative to the fixed portion; and
the movable portion and the driving portion are arranged along a first axis.

3. The driving mechanism as claimed in claim 2, wherein
the driving body further includes a first flexible portion and a first connecting portion;
the movable portion is movably connected to the fixed portion via the first flexible portion;
the first connecting portion is connected to the driving portion, and the first connecting portion has a first connecting surface which faces the driving portion; and
the driving portion has a first surface which faces the first connecting portion and is connected to the first connecting surface.

4. The driving mechanism as claimed in claim 3, wherein
the driving body further includes a second connecting portion which is connected to the driving portion, and the second connecting portion has a second connecting surface which faces the driving portion;
the driving portion has a second surface which faces the second connecting portion and is connected to the second connecting surface; and
the first connecting surface is perpendicular to the first axis.

5. The driving mechanism as claimed in claim 4, wherein
the first flexible portion has a first flexible portion surface which is perpendicular to a second axis;
when viewed along the second axis, the first flexible portion does not overlap the driving portion; and
the first axis and the second axis are perpendicular to each other;
the first flexible portion and the driving portion are arranged along a third axis; and
the third axis, the first axis and the second axis are perpendicular to each other.

6. The driving mechanism as claimed in claim 5, wherein
the first flexible portion further has a second flexible portion surface;
the first flexible portion surface and the second flexible portion surface face opposite directions;
the first flexible portion further has a first notch and a second notch;
the first notch is formed on the first flexible portion surface; and
the second notch is formed on the second flexible portion surface.

7. The driving mechanism as claimed in claim 6, wherein
when viewed along the second axis, the first notch overlaps at least a portion of the second notch; and
a depth of the first notch is different from a depth of the second notch;
the first flexible portion further has a third flexible portion surface and a fourth flexible portion surface;
the third flexible portion surface is perpendicular to the first flexible portion surface; and
the fourth flexible portion surface and the third flexible portion surface face opposite directions.

8. The driving mechanism as claimed in claim 7, wherein
the first flexible portion further has a third notch and a fourth notch;
the third notch is formed on the third flexible portion surface; and
the fourth notch is formed on the fourth flexible portion surface;
when viewed along the third axis, the third notch overlaps at least a portion of the fourth notch; and
a depth of the third notch is different from a depth of the fourth notch.

9. The driving mechanism as claimed in claim 8, wherein
the driving portion is configured to drive the movable portion to move in a first dimension, and movement in the first dimension at least includes movement along the second axis;
when the driving portion drives the movable portion to move, a movement trajectory of the contact portion is an arc trajectory;
the arc trajectory has a closed structure; and
the arc trajectory has a center.

10. The driving mechanism as claimed in claim 9, wherein
the arc trajectory defines a central axis which passes through the center;
the central axis is parallel to the third axis;
the central axis is perpendicular to the second axis; and
when viewed along the first axis or the third axis, the central axis does not pass through a center of the driving portion.

11. The driving mechanism as claimed in claim 10, wherein
the driving mechanism further includes a positioning assembly configured to be affixed to the driving assembly;
the positioning assembly includes a positioning member and an elastic member;
the positioning member has a long strip-shaped structure; and
the positioning member passes through a portion of the fixed assembly and the fixed portion of the driving assembly.

12. The driving mechanism as claimed in claim 11, wherein
the elastic member sheathes the positioning member;
the elastic member is disposed between the driving assembly and the fixed assembly;
the elastic member is configured to apply a stabilizing force onto the driving assembly;
a direction of the stabilizing force is not perpendicular to a direction of the driving force; and
the direction of the stabilizing force is not parallel to the first flexible portion surface.

13. The driving mechanism as claimed in claim 12, wherein
the fixed assembly includes an outer casing and a base;
the outer casing is fixedly connected to the base along the second axis; and
when viewed along the first axis, the outer casing and the base surround the driving assembly.

14. The driving mechanism as claimed in claim 13, wherein
the outer casing of the fixed assembly has an avoiding portion corresponding to the second flexible portion surface;
the avoiding portion has an avoiding portion surface which faces the second flexible portion surface;
the driving mechanism further includes a limiting element;
the limiting element is disposed on the fixed assembly and has a limiting surface which faces the driving assembly;
the limiting surface is parallel to the second axis and perpendicular to the first axis; and
the limiting surface is in direct contact with a fixed surface of the driving assembly.

15. The driving mechanism as claimed in claim 14, wherein
the positioning member has a first threaded structure;
the driving body of the driving assembly has a second threaded structure corresponding to the first threaded structure;
the first threaded structure is configured to be screwed to the second threaded structure so that the fixed portion of the driving body is located in a fixed position;
when viewed along the third axis, the positioning member extends along a first extension direction;
when viewed along the third axis, the driving body extends along a second extension direction; and
the first extension direction is not perpendicular to the second extension direction.

16. The driving mechanism as claimed in claim 14, wherein
the positioning member has a limit portion configured to limit the driving assembly to a fixed position;
when the driving assembly is located in the fixed position, the driving assembly contacts the limit portion;
the limit portion has a limit surface which faces the driving assembly;
when viewed along a direction perpendicular to the second axis, at least a portion of the driving assembly is located between the limit portion and the elastic member; and
the avoiding portion surface of the avoiding portion is not perpendicular or parallel to the first flexible portion surface.

17. The driving mechanism as claimed in claim 16, wherein
the driving assembly has a first opening, and at least a portion of the positioning member is located in the first opening;
the positioning member defines a first extension direction;
the positioning member extends along the first extension direction;
when viewed in the first extension direction, an area of the first opening is greater than an area of the first cross section of the positioning member; and
the first extension direction is perpendicular to the first cross section.

18. The driving mechanism as claimed in claim 17, wherein
the area of the first opening is at least 5% greater than the area of the first cross section;
when viewed in the first extension direction, the first opening has a long strip-shaped structure, and the first opening defines a stretch direction; and
when viewed in the first extension direction, a connecting line of a center of the positioning member and a center of the contact member is parallel to the stretch direction.

19. The driving mechanism as claimed in claim 10, wherein
when the driving assembly receives a first control signal, the driving assembly drives the contact member to move in the first dimension;
when the driving assembly receives a second control signal, the driving assembly drives the contact member to move in a second dimension;
the second dimension is opposite to the first dimension;
the first control signal and the second control signal have periodic characteristics; and
a frequency of the first control signal is the same as a frequency of the second control signal.

20. The driving mechanism as claimed in claim 10, wherein
when the driving assembly receives a first control signal, the driving assembly drives the contact member to move in the first dimension;
when the driving assembly receives a second control signal, the driving assembly drives the contact member to move in a second dimension;
the second dimension is opposite to the first dimension;
the first control signal and the second control signal have periodic characteristics; and
a frequency of the first control signal is different from a frequency of the second control signal.
